(19) United States
(12) Patent Application Publication
(10) Pub. No.: US 2020/0120988 A1
(43) Pub. Date: Apr. 23, 2020

(54) ELECTRONIC CIGARETTE AND METHOD FOR PRE-HEATING ELECTRONIC CIGARETTE

(71) Applicant: CHANGZHOU PATENT ELECTRONIC TECHNOLOGY CO., LTD, Changzhou (CN)

(72) Inventor: Weihua QIU, Changzhou (CN)

(21) Appl. No.: 16/717,880

(22) Filed: Dec. 17, 2019

Related U.S. Application Data
(63) Continuation-in-part of application No. PCT/CN2018/092631, filed on Jun. 25, 2018.

(30) Foreign Application Priority Data
Jun. 26, 2017 (CN) 201710497151.6

(51) Int. Cl. A24F 40/57; A24F 40/10; A24F 40/51; G05B 15/02

(52) U.S. Cl. CPC A24F 40/57; G05B 15/02; A24F 40/51; A24F 40/10

(57) ABSTRACT

A method for pre-heating an electronic cigarette includes initializing an electronic cigarette; acquiring and/or invoking a pre-heating parameter of the electronic cigarette; according to the acquired or invoked pre-heating parameter of the electronic cigarette, controlling an atomization apparatus of the electronic cigarette so that same performs pre-heating; and starting the electronic cigarette and smoking with same. By means of the electronic cigarette and the method for pre-heating an electronic cigarette disclosed in the present disclosure, an atomization apparatus of the electronic cigarette is controlled to perform pre-heating by setting a pre-heating parameter of the electronic cigarette, wherein the pre-heating power and pre-heating time of the electronic cigarette are controllable, and a user has an intense experience.

### CROSS-REFERENCE TO RELATED APPLICATIONS

This application is a continuation in part application of PCT/CN2018/092631 filed on Jun. 25, 2018, which claims the benefit of priority from Chinese Patent Application No. 201710497151.6 filed on Jun. 26, 2017, the content of which is incorporated herein by reference in its entirety.

### FIELD OF TECHNOLOGY

The disclosure relates to a technical field of electronic cigarette, and more particularly, relates to an electronic cigarette and a pre-heating method of the electronic cigarette.

### BACKGROUND

Due to the increasing concerns about human health and environment safety, consumers are conscious of the great threats of the cigarette to human body, therefore, a product named “electronic cigarette” is brought up. The electronic cigarette is also known as virtual cigarette or electronic atomizer. It has an appearance same as the cigarette, and has a flavor similar to that of the cigarette, and even has more flavors than that of the cigarette. The electronic cigarette also provides aerosol for user to swallow like that of cigarette, it has a smell and feel similar to that.

The related electronic cigarette is generally constituted by three parts: a battery, an atomizer, and a mouth piece. In the related electronic cigarette, when in use, the atomizer is started to atomize the tobacco liquid. Because in every time, the atomizer is required to heat up the tobacco liquid to an atomization temperature or even higher, user is required to wait for a period of time, and the power consumption of the battery is increased. For a long time use, a large depletion of the battery is caused, and a poor experience is brought to user.

### SUMMARY OF THE INVENTION

A main object of the disclosure is to provide an electronic cigarette and a pre-heating method of the electronic cigarette, aiming at resolve the large depletion of the battery in the related electronic cigarette, and eliminate the poor experience brought to user at the same time.

In order to achieve aforementioned purpose, a first aspect of the embodiment of the disclosure is to provide an electronic cigarette. The electronic cigarette includes a battery, an atomizer, and a main controller. The main controller is connected to the battery and the atomizer. The main controller is configured to obtain a pre-heating parameter via an inputting module receiving user's inputted instruction, and/or call up a preset pre-heating parameter, the main controller is further configured to control the atomizer to conduct a pre-heating, according to the pre-heating parameter.

Further, the user's inputted instruction includes user's operation instructions and data inputted instructions, the user's operation instructions includes an electronic cigarette initializing instruction, an electronic cigarette pre-heating instruction, and an electronic cigarette inhalation instruction, the date inputted instruction includes inputted pre-heating parameters, the main controller performs an electronic cigarette initialization after receiving the electronic cigarette initializing instruction, and controls the atomizer to conduct a pre-heating after receiving an electronic cigarette pre-heating instruction, and starts the electronic cigarette for inhalation after receiving the electronic cigarette inhalation instruction.

Further, the pre-heating parameters includes a pre-heating power/voltage, and/or, a pre-heating duration, the pre-heating power/voltage is any value falling within the range of the outputting power/outputting voltage of the electronic cigarette, or is any one among multiple pre-heating powers/pre-heating voltages, the pre-heating duration is any value within the range of a preset time periods, or is any one among multiple pre-heating durations.

Further, the main controller is configured to store the pre-heating parameter of the electronic cigarette inputted by the inputting module, when the main controller does not receive the inputting pre-heating parameter, a previous saved pre-heating parameter of the electronic cigarette is assigned as the present pre-heating parameter of the electronic cigarette by the main controller.

Further, the atomizer of the electronic cigarette includes a liquid storage assembly and an atomizing assembly, the liquid storage assembly defines a liquid storage chamber, the atomizing assembly includes an atomizing head, an inner of the atomizing head is provided with a heating member and defines an atomizing chamber, the atomizing assembly forms an air intake passage outside the atomizing head, the air intake passage is in communication with the atomizing chamber.

Further, the preset pre-heating parameter includes a pre-heating control information of the electronic cigarette, the pre-heating control information includes a corresponding relation between a temperature of a heating member and a pre-heating action, when the temperature of the heating member is less than a preset temperature of the heating member, the main controller controls the heating member to heat, until the temperature of the heating member is equivalent to or greater than the preset temperature of the heating member.

Further, the main controller is further configured to adjust a pre-heating power according to a difference between a real-time temperature of the heating member and the preset temperature.

Further, the air intake passage is provided with an air intake auxiliary heating member for heating the air in the air intake passage, the air intake passage include an air intake opening and an air outlet, the air intake opening is provided with an air intake temperature sensor for detecting the air temperature in the air intake opening, and the air outlet is provided with an air outlet temperature sensor for detecting the air temperature in the air outlet.

Further, the preset pre-heating parameters include a pre-heating control information of the electronic cigarette, the reheating control information includes a corresponding relation between a temperature in the air outlet and a pre-heating action, when the temperature of in the air outlet is less than a preset temperature in the air outlet, the main controller starts to employ the air intake auxiliary heating member to pre-heat the air entering the atomizer, until the temperature in the air outlet is equivalent to or greater than the preset temperature in the air outlet.

Further, the pre-heating control information includes a corresponding relation that between a temperature difference between the air intake opening and the air outlet, and a heating power of the air intake auxiliary heating member, when the temperature difference between the air intake opening and the air outlet is decreased, the pre-heating power is decreased.

Further, the liquid storage chamber is provided with a tobacco liquid auxiliary heating member for heating the tobacco liquid, and a tobacco liquid temperature sensor for detecting the temperature of the tobacco liquid.

Further, the preset pre-heating parameter include a pre-heating control information of the electronic cigarette, the reheating control information includes a corresponding relation between a temperature of the tobacco liquid and a pre-heating action, when the temperature of the tobacco liquid is less than a preset temperature of the tobacco liquid, the main controller starts to employ the tobacco liquid auxiliary heating member to pre-heat the tobacco liquid in the liquid storage assembly, until the temperature of the tobacco liquid is equivalent to or greater than the preset temperature of the tobacco liquid.

In order to achieve aforementioned purpose, a second aspect of the embodiment of the disclosure is to provide a pre-heating method of the electronic cigarette, the method includes:

acquiring and/or invoking a pre-heating parameter of the electronic cigarette; and

controlling an atomizer of the electronic cigarette to conduct a pre-heating according to the acquired and/or invoked pre-heating parameter of the electronic cigarette.

Further, in the step of acquiring and/or invoking a pre-heating parameter of the electronic cigarette, the pre-heating parameters includes a pre-heating power/voltage, and/or, a pre-heating duration.

Further, the electronic cigarette compromises a main controller and an inputting module connected to the main controller, the step of acquiring a pre-heating parameter of the electronic cigarette includes acquiring the pre-heating parameter inputted by the inputting module via the main controller, the step of invoking a pre-heating parameter of the electronic cigarette includes invoking a preserved pre-heating control information by the main controller, the step of acquiring and invoking the pre-heating parameter of the electronic cigarette includes acquiring a part of the pre-heating parameter inputted into the inputting module by the main controller, and acquiring the residual part of the pre-heating parameter by invoking the pre-heating control information via the main controller.

Further, the atomizer of the electronic cigarette includes a liquid storage assembly and an atomizing assembly, the liquid storage assembly defines a liquid storage chamber, the atomizing assembly includes an atomizing head, an inner of the atomizing head is provided with a heating member and defines an atomizing chamber, the atomizing assembly forms an air intake passage outside the atomizing head, the air intake passage is in communication with the atomizing chamber, the air intake passage is provided with an air intake auxiliary heating member for heating the air in the air intake passage, the air intake passage include an air intake opening and an air outlet, the air intake opening of the air intake passage is provided with an air intake temperature sensor for detecting the air temperature in the air intake opening, and the air outlet is provided with an air outlet temperature sensor for detecting the air temperature in the air outlet, the liquid storage chamber is provided with a tobacco liquid auxiliary heating member for heating the tobacco liquid, and a tobacco liquid temperature sensor for detecting the temperature of the tobacco liquid.

Further, the pre-heating control information includes at least one of the following corresponding relations: a corresponding relation between a temperature of the heating member and a pre-heating action; a corresponding relation between a temperature of the tobacco liquid and a pre-heating action; a corresponding relation between a temperature in the air outlet and a pre-heating action; a corresponding relation between a real-time temperature of the heating member and a heating power of the heating member; a corresponding relation between a real-time temperature of the tobacco liquid and a heating power of the tobacco liquid auxiliary heating member; a corresponding relation between a real-time temperature in the air outlet and a heating power of the air intake auxiliary heating member; a corresponding relation between a target temperature of the tobacco liquid and a target temperature in the air outlet; a corresponding relation between a target temperature in the air outlet, a target temperature of the tobacco liquid, and a pre-heating power; a corresponding relation between a target temperature in the air outlet, a target temperature of the tobacco liquid, and a target temperature of the heating member; and a corresponding relation between a difference that between the temperature in the air intake opening and the temperature in the air outlet, and a heating power of the air intake auxiliary heating member.

Further, when the electronic cigarette initializing instruction is received, the main controller invokes the pre-heating parameter of the electronic cigarette automatically, and controls the atomizer of the electronic cigarette to pre-heat.

Further, the pre-heating control information includes a corresponding relation between a target temperature of the tobacco liquid and a target temperature in the air outlet, the pre-heating method further includes:

determining a target temperature first, wherein the target temperature is one of the target temperature of the tobacco liquid and the target temperature in the air outlet; and acquiring the other one temperature information from the target temperature of the tobacco liquid and the target temperature in the air outlet by the main controller, according the pre-heating control information.

Further, the pre-heating control information includes a corresponding relation between a target temperature in the air outlet, a target temperature of the tobacco liquid, and a target temperature of the heating member, the pre-heating method further includes:

determining a target temperature first, wherein the target temperature is one of the three temperatures: the target temperature in the air outlet, the target temperature of the tobacco liquid, and the target temperature of the heating member, and invoking the other two temperature information by the main controller according to the pre-heating control information;

or, determining two target temperatures first, wherein the target temperatures are two of the three temperatures: the target temperature in the air outlet, the target temperature of the tobacco liquid, and the target temperature of the heating member; and invoking the other one temperature information by the main controller, according to the pre-heating control information; and

controlling the air intake auxiliary heating member, the tobacco liquid auxiliary heating member and the heating member by the main controller to conduct a heating at the same time, and controlling the temperature of the tobacco liquid, the temperature of the heating member, and the temperature in the air outlet to reach a preset temperature in the pre-heating control information one by one, or at the same time.

In the electronic cigarette provided by the embodiment of the disclosure, by a configuration of the pre-heating parameter of the electronic cigarette, and a control of a pre-heating of the atomizer of the electronic cigarette, the electronic cigarette is started automatically for inhalation after the pre-heating is finished, the pre-heating power and the pre-heating duration of the electronic cigarette are controllable, the user's experience is improved.

### BRIEF DESCRIPTION OF THE DRAWINGS

FIG. 1 is a schematic view of an electronic cigarette provided by a first embodiment of the disclosure.

FIG. 2 is a process diagram of a pre-heating method of an electronic cigarette provided by a second embodiment of the disclosure.

FIG. 3 is a process diagram of acquiring a pre-heating parameter and other functional parameters of the electronic cigarette according to the second embodiment of the disclosure.

FIG. 4 is a schematic view of an atomizer of an electronic cigarette provided by a third embodiment of the disclosure.

FIG. 5 is a schematic diagram of a first pre-heating control form in the electronic cigarette provided by the third embodiment of the disclosure.

FIG. 6 is a schematic diagram of a second pre-heating control form in the electronic cigarette provided by the third embodiment of the disclosure.

FIG. 7 is a schematic diagram of a third pre-heating control form in the electronic cigarette provided by the third embodiment of the disclosure.

FIG. 8 is a schematic diagram of a fourth pre-heating control form in the electronic cigarette provided by the third embodiment of the disclosure.

FIG. 9 is a schematic diagram of a fifth pre-heating control form in the electronic cigarette provided by the third embodiment of the disclosure.

FIG. 10 is a schematic diagram of a sixth pre-heating control form in the electronic cigarette provided by the third embodiment of the disclosure.

FIG. 11 is a schematic diagram of a seventh pre-heating control form in the electronic cigarette provided by the third embodiment of the disclosure.

FIG. 12 is a schematic diagram of a eighth pre-heating control form in the electronic cigarette provided by the third embodiment of the disclosure.

FIG. 13 is a schematic diagram of a ninth pre-heating control form in the electronic cigarette provided by the third embodiment of the disclosure.

FIG. 14 is a schematic diagram of a tenth pre-heating control form in the electronic cigarette provided by the third embodiment of the disclosure.

FIG. 15 is a process diagram of a pre-heating method of the electronic cigarette provided by the third embodiment of the disclosure.

To make the objectives, technical solutions, and advantages of the present disclosure clearer, the following further describes the embodiments of the present disclosure in detail with reference to the accompanying drawings.

### DETAILED DESCRIPTION OF THE PREFERRED EMBODIMENT

It should be noted that, the specified embodiment described hereby is for the purpose of illustrated the disclosure, not limited to the disclosure.

It should be noted that when an element is described as “fastened to” or “disposed on” another element, the element may be directly on the another element, or a mediate element may also exist; when an element is described as “connected to” another element, the element may be directly connected to the another element, or a mediate element may also exist.

### The First Embodiment

As shown in FIG. 1, in the illustrated embodiment, an electronic cigarette is provided. The electronic cigarette includes a main controller, a battery, a power controller, an atomizer, a display and an inputting module, the main controller is connected to the power controller, the display and the inputting module, the power controller is connected to the atomizer, the display and the battery.

The battery is configured to supply power for the atomizer, the display and the battery of the electronic cigarette, via the power controller.

The power controller is configured to control the battery to distribute appropriate electric quantity to the atomizer, the display and the battery.

The atomizer is configured to atomize the tobacco liquid in the electronic cigarette according to a control of the main controller, thereby the tobacco liquid is swallowed by user.

The inputting module is configured to receive user's inputted instructions, including user's operation instructions and data inputted instructions, the inputting module is but not limited to a mechanic button or a touch screen.

In the illustrated embodiment, the inputting module includes but not limited to a mechanic button or a touch screen. User's operational order inputted instruction includes but not limited to an electronic cigarette initializing instruction, a pre-heating instruction, a inhalation instruction and so on. In the illustrated embodiment, user's operational order inputted instruction is the electronic cigarette pre-heating instruction. The user's operational order inputted instruction can be inputted by a mechanic button (e.g. a power source switch, a pre-heating switch, an inhalation switch, an adding or misusing press button, and a selecting press button), furthermore, the user's operational order inputted instruction can be inputted via a touch screen. The data inputted instruction includes an inputting of a specific value, or an inputting of a selection of a setting, the data inputted instruction is mainly configured to configure or call the pre-heating parameter of the electronic cigarette.

The main controller is configured to determine whether there is a user's inputted instruction, and controls the electronic cigarette to conduct a corresponding operation according to user's operational order instruction (for example, conducting an initializing operation of the electronic cigarette according to a switching on instruction of the power source switch) when there is a user's inputted instruction in the inputting module, the pre-heating parameter is acquired or invoked according to the data inputted instruction, the atomizer is controlled to pre-heat according to the acquired or invoked pre-heating parameter of the electronic cigarette. After the pre-heating process is completed or during the pre-heating process, the electronic cigarette is started according to user's operational order instruction or is started automatically, for user to inhale. In the illustrated embodiment, the main controller is automatically started for inhalation after the pre-heating process is completed.

It can be understand that: in alternative embodiments, the power controller can be omitted, at the time, the main controller is directly connected to the battery and the inputting module.

In the illustrated embodiment, the pre-heating parameters of the electronic cigarette include a pre-heating power/voltage, and/or, a pre-heating duration of the heating member of the atomizing head. A pre-heating power/voltage can be any value falling within the range of the outputting power/outputting voltage of the electronic cigarette, or can be any one among multiple pre-heating powers/pre-heating voltages of the electronic cigarette, the pre-heating duration can be any value falling within the range of a preset time periods, or can be any one among multiple pre-heating durations. In a specified embodiment, the range of the preset time period varies from 0.1 second to 2 second.

It should be noted that the pre-heating power/voltage, and/or, the pre-heating duration can be configured according to aforementioned setting or a combination of any value. For example, a pre-heating power/voltage and the pre-heating duration have a setting that includes two modes: one mode is that, one pre-heating power/voltage corresponds to one pre-heating duration (such as, in a first mode, the pre-heating voltage is 2 volts, the pre-heating duration is 0.2 second), thereby, after the specified setting is selected, the corresponding pre-heating power/voltage and the pre-heating duration is constant and cannot be changed, the other mode is that, one pre-heating power/voltage corresponds to multiple pre-heating durations (for example, in a first setting, the pre-heating voltage is 2 volts, the pre-heating duration is 0.2 second, 0.3 second and 0.4 second), or one pre-heating duration corresponds to multiple pre-heating power/voltage (for example, in a first setting, the pre-heating duration is 0.2 second, the pre-heating voltage is 2 volts, 2.5 volts and 3 volts), thereby after the specified setting is selected, a pre-heating duration or a pre-heating power/voltage can be adjusted.

It should be noted that: the main controller determining whether there is an operation inputting is mainly determined by whether a data signal transferred by the inputting module is received. If the data signal transferred by the inputting module is received by the main controller, thus it can be determined that there is an operation inputting is in the inputting module, or else there is no operation inputting in the inputting module.

Further, the main controller usually includes a memory, thereby the memory is configured to save the pre-heating parameter of the electronic cigarette configured by the inputting module. It can be understand that: the pre-heating parameter of the electronic cigarette configured by the inputting module can be saved by individual memory or other memories.

In an alternative embodiment, the main controller is further used to configure a previous saved pre-heating parameter of the electronic cigarette as the present pre-heating parameter of the electronic cigarette, when there is no data inputting (i.e. the pre-heating parameter of the electronic cigarette is not updated), the main controller further controls the atomizer to conduct a pre-heating according to the previous saved pre-heating parameter of the electronic cigarette, and after the pre-heating is completed, the electronic cigarette is started for inhalation.

Further, the display is configured to display a main interface of the electronic cigarette after an initiating of the electronic cigarette, and display corresponding interface according to user's operation, the information included in the interface displayed by the display includes a pre-heating parameter of the electronic cigarette inputted by the inputting module and a pre-heating parameter of the electronic cigarette stored in the main controller.

In the illustrated embodiment, the display includes but not limited to a LED display device, a LCD device, or an OLED device and so on.

In the electronic cigarette provided by the embodiment of the disclosure, by a configuration of the pre-heating parameter of the electronic cigarette, and a control of a pre-heating of the atomizer of the electronic cigarette, the electronic cigarette is started automatically for inhalation after the pre-heating is finished, the pre-heating power and the pre-heating duration of the electronic cigarette are controllable, the user's experience is improved.

### The Second Embodiment

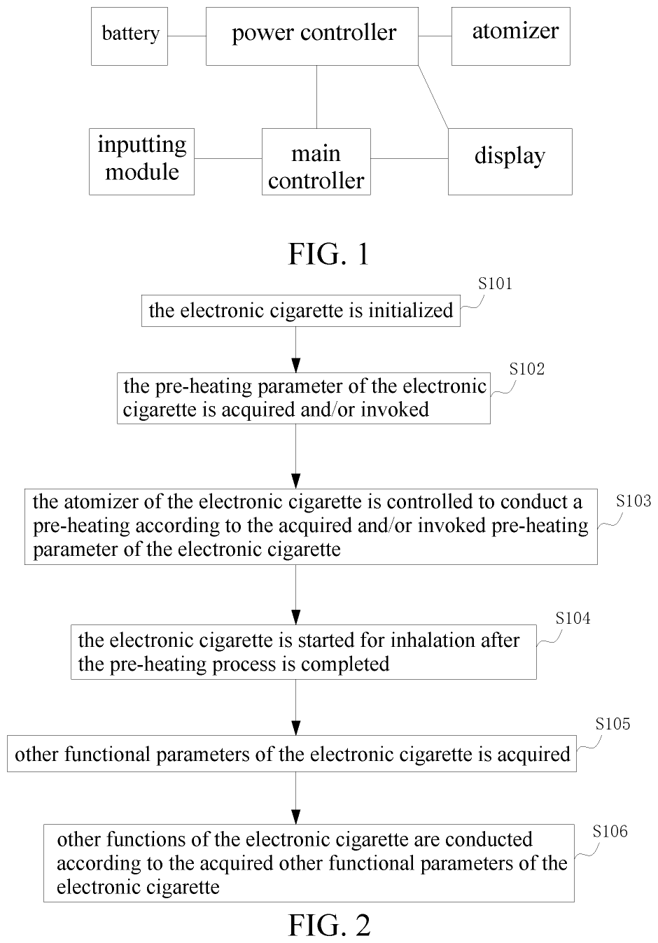

As shown in FIG. 2, a pre-heating method of an electronic cigarette is provided in the illustrated embodiment, the pre-heating method includes the following steps:

In step S101, the electronic cigarette is initialized;

In step S102, the pre-heating parameter of the electronic cigarette is acquired and/or invoked;

In the illustrated embodiment, the acquired pre-heating parameters of the electronic cigarette include a pre-heating power/voltage, and/or, a pre-heating duration. A pre-heating power/voltage can be any value falling within the range of the outputting power/outputting voltage of the electronic cigarette, or can be any one among multiple pre-heating powers/pre-heating voltages of the electronic cigarette, the pre-heating duration can be any value falling within the range of a preset time periods, or can be any one among multiple pre-heating durations. In a specified embodiment, the range of the presetting time period varies from 0.1 second to 2 second.

It should be noted that a pre-heating power/voltage, and/or, a pre-heating duration can be configured according to aforementioned setting or a combination of any value. For example, a pre-heating power/voltage and a pre-heating duration has a setting that are two modes: one mode is that, one pre-heating power/voltage corresponds to one pre-heating duration (for example, in a first setting, the pre-heating voltage is 2 volts, the pre-heating duration is 0.2 second), thereby, after the specified setting is selected, the corresponding pre-heating power/voltage and the pre-heating duration is constant and cannot be changed, the other mode is that, one pre-heating power/voltage corresponds to multiple pre-heating durations (for example, in a first setting, the pre-heating voltage is 2 volts, the pre-heating duration is 0.2 second, 0.3 second and 0.4 second), or one pre-heating duration corresponds to multiple pre-heating power/voltage (for example, in a first setting, the pre-heating duration is 0.2 second, the pre-heating voltage is 2 volts, 2.5 volts and 3 volts), thereby after the specified setting is selected, the pre-heating power/voltage and the pre-heating duration can be adjusted.

In the illustrated embodiment, the pre-heating parameter of the electronic embodiment can be acquired by the following two ways: first, acquiring by user's data inputting; second, when the main controller does not receive the present data inputting, the main controller invokes the previous saved pre-heating parameter of the electronic cigarette as the present pre-heating parameter of the electronic cigarette.

Further, the pre-heating method of the electronic cigarette in the illustrated embodiment further includes:

In step S103, the atomizer of the electronic cigarette is controlled to conduct a pre-heating according to the acquired and/or invoked pre-heating parameter of the electronic cigarette.

In step S104: the electronic cigarette is started for inhalation after the pre-heating process is completed.

In the illustrated embodiment, when user is not required to reset the pre-heating parameter of the electronic cigarette during the present operation, thereby the required action only involves pressing down the power source switch and the inhalation switch of the electronic cigarette, when the power source switch is pressed down, the electronic cigarette is initialized automatically, when the inhalation switch is pressed down, the electronic cigarette conducts a pre-heating action automatically, i.e the main controller invokes the pre-heating parameter directly, and the electronic cigarette is started automatically for inhalation after the pre-heating process is completed. When user is required to reset the pre-heating parameter of the electronic cigarette during the present operation, thereby the operation of the data inputting is required after the electronic cigarette is initialized. In other alternative embodiments, when an initializing instruction of the electronic cigarette is received, the main controller invokes the pre-heating parameter of the electronic cigarette automatically, and controls the atomizer of the electronic cigarette to conduct a pre-heating, i.e. the main controller has an automatic pre-heating function. In other alternative embodiment, the pre-heating parameter can further be acquired and invoked, an optional way in one embodiment is that: user selects one pre-heating power by the inputting module, thereby, a pre-heating control information relevant to the selected pre-heating power is invoked by the main controller, for example, the pre-heating controlling information includes: when a pre-heating power maintains for 2 second, it stops for 1 second, and pre-heating for 2 second with a half power of the previous power, in the end the pre-heating information is finished.

It should be noted that: the electronic cigarette in the disclosure can further have other functions, for example, a wireless transmitting function, an electrocardiogram monitoring function, an infrared temperature measurement function, a voice broadcasting function and so on. In order to realize aforementioned functions, the parameter configuration should be conducted in the corresponding interfaces of the electronic cigarette.

In other alternative embodiments of the disclosure, the electronic cigarette having other functions, in step S102 of the electronic cigarette of the disclosure, in addition to obtain the pre-heating parameter of the electronic cigarette, acquiring other functional parameters is further required.

Correspondingly, the pre-heating method of the electronic cigarette of the disclosure further includes the following steps:

In step S105: other functional parameters of the electronic cigarette is acquired;

In step S106: other functions of the electronic cigarette are conducted according to the acquired other functional parameters of the electronic cigarette.

It should be noted that: the steps for executing other functions of the electronic cigarette can be conducted prior to finishing the pre-heating of the electronic cigarette, for example, after the wireless transmitting parameter, the electrocardiogram monitoring parameter, and the voice broadcasting parameter of the electronic cigarette are configured, and the wireless transmitting function, the electrocardiogram monitoring function, and the voice broadcasting function are directly executed. After conducting the electrocardiogram monitoring function, the monitoring data can be transferred to other mechanism or device via the monitored information of the voice broadcasting or the wireless transmitting way, furthermore, other functional steps can be conducted during the pre-heating process of the electronic cigarette or after the pre-heating process is completed. For example, during the pre-heating process, the pre-heating temperature can be broadcasted at regular intervals, or broadcasting “the pre-heating is completed, it can be swallowed” after the pre-heating process is completed.

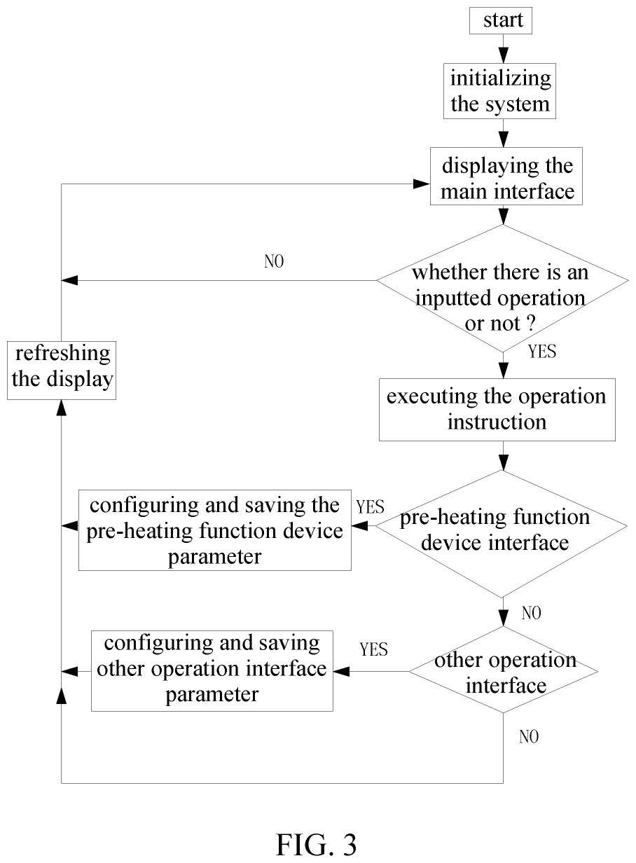

Further, in the step S102 and S105, the specified operation procedure of acquiring the pre-heating parameter and the other functional parameters of the electronic cigarette can be referred to FIG. 3. As shown in FIG. 3, exemplary, the acquiring procedure of the pre-heating parameter and other functional parameters of the electronic cigarette includes the following steps:

In step S1: the electronic cigarette is started to work, the system is initialized and shows the main interface.

In step S2: the main interface is monitored to determine whether there is an inputting operation instruction, if there is an inputting operation instruction, the inputting operation instruction is conducted, the corresponding function device interface is entered according to the inputting operation instruction, if there is no inputting operation instruction, the main interface is retained.

In the step, the inputted operation instruction in the main interface includes the inputted operation instructions of entering the pre-heating function device interface and entering other function device interfaces.

In the illustrated embodiment, the inputting operation instruction is conducted by the inputting module, the inputting module includes a mechanic button or a touch screen.

In step S3: the pre-heating device interface is monitored to determine whether there is an inputting operation instruction including a data inputted instruction or a setting selection instruction, when there is an inputting operation instruction, a configuration and a storage of the parameter of the pre-heating function device interface is conducted, and the displaying is refreshed and returns to the main interface; or else, the previous saved pre-heating parameter of the electronic cigarette is assigned as the present pre-heating parameter of the electronic cigarette.

Specifically, when it is detected that there is an inputting operation instruction in the pre-heating function device

interface, i.e. the inputting operation instruction signal in the pre-heating device interface is received by the main controller, it indicates that user conduct an operation of the pre-heating parameter of the electronic cigarette in the pre-heating function device interface, the main controller saves the corresponding pre-heating parameter of the electronic cigarette after the inputting operation instruction signal is received, and after the pre-heating parameter of the electronic cigarette is configured, the step S103 and the step S104 are executed, i.e. the atomizer is controlled to perform a pre-heating according to the configured pre-heating parameter of the electronic cigarette, the electronic cigarette is started automatically for inhalation after the pre-heating is completed.

When no inputting operation instruction in the pre-heating function device interface are detected, i.e. the main controller does not receive the inputting operation instruction signal in the pre-heating function device interface, the previous saved pre-heating parameter of the electronic cigarette is assigned as the present pre-heating parameter of the electronic cigarette, the step S103 and the step S104 are executed according to the present pre-heating parameter of the electronic cigarette, i.e. the atomizer is controlled to perform a pre-heating according to the previous saved pre-heating parameter of the electronic cigarette, the electronic cigarette is started automatically for inhalation after the pre-heating is completed.

It should be noted that: in the step, after the pre-heating parameter of the electronic cigarette is configured, the operation for entering the step S103 and S104 is completed by clicking the touch screen or by pressing down the corresponding button, or a predetermined time period is preset in the main controller, for example, the time period is 10 second, if the main controller does not receive a new inputting operation instruction when the main controller enters the pre-heating function device interface for a preset time period or for a time period after an inputting operation instruction in the pre-heating function device interface, then it automatically jumps to a latter step, the atomizer is controlled by the main controller to perform a pre-heating according to the configured pre-heating parameter or the previous saved pre-heating parameter of the electronic cigarette, the electronic cigarette is started automatically for inhalation after the pre-heating is completed.

Further, in the disclosure, the electronic cigarette is provided with other functions, for example, the wireless transmitting function, the electrocardiogram monitoring function, the infrared temperature measurement function and the voice broadcasting function, and so on. In alternative embodiments, the setting operation of the working parameter of the electronic cigarette further includes the following steps:

In step S4: the other function interface is detected to determine whether there is an inputting operation instruction, if there is an inputting operation instruction, the other functional parameter is configured and saved, and the display screen is refreshed and returns to the main interface, or else, the previous saved other functional parameter of the electronic cigarette is assigned as the present other functional parameter of the electronic cigarette. In the illustrated embodiment, the other function module interface includes but not limited to the wireless transmitting module interface, the electrocardiogram monitoring mechanism interface, the infrared temperature measurement mechanism interface and the voice broadcasting mechanism interface and so on.

Specifically, when it is detected that there is an inputting operation instruction in the other function module interface, i.e. the inputting operation instruction signal in the other function module interface is received by the main controller, it indicates that user conducts an operation of the other functional parameter of the electronic cigarette in the other function module interface, the main controller saves the corresponding other functional parameter of the electronic cigarette after the inputting operation instruction signal is received, and after the other functional parameter of the electronic cigarette is configured, the step S106 is executed, i.e. the other functions are conducted according to the configured other functional parameter of the electronic cigarette.

When no inputting operation instruction in the other function module interface is detected, i.e. the main controller does not receive the inputting operation instruction signal in the other function module interface, the previous saved other functional parameter of the electronic cigarette is assigned as the default value of the present other functional parameter of the electronic cigarette by the main controller, the step S106 is executed according to the present other functional parameter of the electronic cigarette.

In the pre-heating method of the electronic cigarette provided by the embodiment of the disclosure, by a configuration of the pre-heating parameter of the electronic cigarette, and a control of a pre-heating of the atomizer of the electronic cigarette, the electronic cigarette is started automatically for inhalation after the pre-heating is finished, the pre-heating power and the pre-heating duration of the electronic cigarette are controllable, the user's experience is improved.

### The Third Embodiment

A pre-heating method of an electronic cigarette is provided by the illustrated embodiment.

The electronic cigarette in the illustrated embodiment is similar to the electronic cigarette in the first embodiment, both include a main controller, a battery, a power controller, an atomizer, and an inputting module. Furthermore, the electronic cigarette further includes a power controller and/or a display, the function and the connecting way of the component parts of aforementioned electronic cigarette are same as that in the first embodiment, which is not specifically described. The main difference between the electronic cigarette provided by the third embodiment and the first embodiment is that, the structures of the atomizer are different.

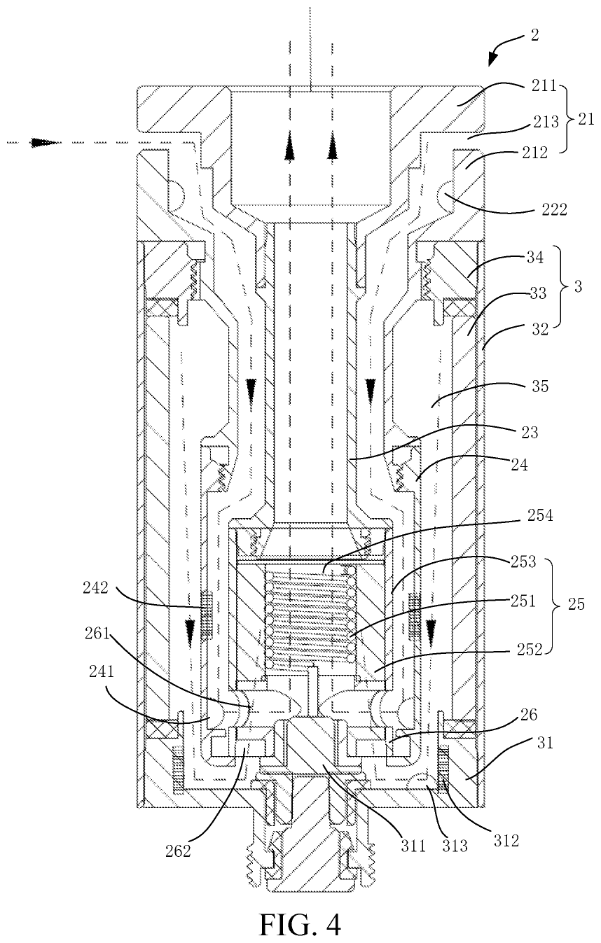

As shown in FIG. 4, the atomizer of the electronic cigarette provided by the third embodiment includes an atomizing assembly 2 and a liquid storage assembly 3 having a liquid storage chamber 35. An end of the liquid storage assembly 3 is provided with an opening (not labeled) for injecting tobacco liquid, the atomizing assembly 2 is inserted in the liquid storage assembly 3 via the opening, the atomizer further includes an auxiliary heating member for pre-heating, the auxiliary heating member includes a tobacco liquid auxiliary heating member 312, and an air intake auxiliary heating member 242, the auxiliary heating member is connected to the main controller. It can be understand that: both the tobacco liquid auxiliary heating member 312 and the air intake auxiliary heating member 242 include a heater. In an alternative embodiment, the heater is a ni-chrome heating strip, in other alternative embodiment, the heater can also be mechanisms such as an electro-thermal film.

In an alternative embodiment, the atomizing assembly 2 includes a month piece connector 21, a ventilation tube 23, an atomizing head sleeve 24, an atomizing head 25, and an atomizing head assembly base 26. The month piece connector 21 defines an air intake opening 213, the month piece connector 21 is divided into a part positioned in an inner side of the air intake opening 213 and a part positioned in an outer side of the air intake opening 213, hereinafter named as the internal tubular portion 211 and the external tubular portion 212, respectively, the lower end of the internal tubular portion 211 is fixedly connected to the upper end of the ventilation tube 23. The external tubular portion 212 is positioned on a periphery of the ventilation tube 23, the external tubular portion 212 is spaced from the periphery of the ventilation tube 23, forming a passage for the air passing through. The air intake opening 213 is provided with an air intake temperature sensor 222 on the inner sidewall of the external tubular portion 212. The lower end of the external tubular portion 212 is fixedly connected to the upper end of the atomizing head sleeve 24 by threaded, the atomizing head 25 is positioned in the inner space of the atomizing head sleeve 24. The atomizing head 25 is spaced from the atomizing head sleeve 24, a passage is formed between the atomizing head 25 and the atomizing head sleeve 24 for the air passing through. The upper end of the atomizing head 25 is fixedly connected to the lower end of the ventilation tube 23, a middle passage of the ventilation tube 23 is in communication with the outlet of the month piece connector 21, for user to swallow the smoke via the month piece. The atomizing head assembly base 26 is positioned on the lower end of the atomizing head 25. A bottom of the atomizing head assembly base 26 defines an air outlet 261 extending along a radial direction. The lower end defines a tobacco liquid intake opening 262 extending an axial direction. An inner side of a bottom of the atomizing head sleeve 24 is provided with an air outlet temperature sensor 241 corresponding to the position of the air outlet 261, and the atomizing head sleeve 24 is provided with an air intake auxiliary heating member 242 corresponding to the middle position of the atomizing head 25, for heating the air entering the atomizing head 25. When the air intake, the air enters the passage between the external tubular portion 212 and the ventilation tube 23 from the air intake opening 213 of the month piece connector 21, and then the air passes through the passage between the atomizing head sleeve 24 and the atomizing head 25, and enters the atomizing head 25 via the air outlet 261 of the atomizing head assembly base 26, that is, the atomizer forms an air intake passage between the air intake opening 213 and the air outlet 261 of the atomizing assembly 2. In the illustrated embodiment, the air intake opening 213 on an end of the air intake passage is positioned on the month piece connector 21, the air outlet 261 of an opposite end of the air intake passage is positioned on the atomizing head assembly base 26. In other alternative embodiments, the positions of the air intake opening 213 and the air outlet 261 can be different, if only the air can flow into the inner side of the atomizing head 25 from outside of the electronic cigarette.

The atomizing head 25 includes a heating member 251, a liquid absorbing member 252, a housing 253 and an atomizing chamber 254, the liquid absorbing member 252 is in communication with the liquid storage chamber 35 and the atomizing chamber 254 through the tobacco liquid intake opening 262 on the lower end of the atomizing head assembly base 26, the liquid absorbing member 252 absorbs the tobacco liquid in the liquid storage chamber 35 for supplying to the heating member 251 in the atomizing chamber 254, after the atomizer is powered on, the heating member 251 heats up the tobacco liquid to be atomized for the user to swallow. The housing 253 is wrapped up the liquid absorbing member 252 and the heating member 251, the upper end of the housing 253 is fixedly connected to the lower end of the ventilation tube 23. The atomizing head assembly base 26 is positioned on the lower end of the housing 253. The liquid storage assembly 3 includes an atomizer base 31 positioned beneath the atomizing head assembly base 26, the atomizer base 31 is provided with an electric connector assembly 311, for electrically connecting the heating member 251 to a battery or an external power source of the electronic cigarette. The atomizer base 31 is provided with a tobacco liquid auxiliary heating member 312 and a tobacco liquid temperature sensor 313 which are adjacent to the position of the tobacco liquid intake opening 262 of the atomizing head assembly base 26, for auxiliary heating the tobacco liquid in the atomizing head 25 and measuring a temperature of the tobacco liquid entering the atomizing head 25. In the illustrated embodiment, the tobacco liquid auxiliary heating member 312 and the tobacco liquid temperature sensor 313 are not restricted, such as, in other alternative embodiment, the tobacco liquid auxiliary heating member 312 and the tobacco liquid temperature sensor 313 can also be positioned in the atomizing chamber 254. When in the atomizing head 25, the tobacco liquid auxiliary heating member 312 and the tobacco liquid temperature sensor 313 can be positioned on the position adjacent to the tobacco liquid intake opening 262 or other positions. In the illustrated embodiment, the heating member 251 is a ni-chrome heating strip, the liquid absorbing member is a fiber rope. In other alternative embodiment, the heating member 251, the liquid absorbing member 252 can be made of other appropriate materials. For convenience, in the following, when there is no “atomizing head” before the “heating member”, the “heating member” also indicates the atomizing head heating member.

Further, the liquid storage assembly 3 further includes an outer supporting bracket 32, a glass sleeve 33, and a connector ring 34. The atomizer base 31 is fixed to the lower end of the outer supporting bracket 32, the glass sleeve 33 is sleeved in the outer supporting bracket 32. The connector ring 34 is fixed to the upper end of the outer supporting bracket 32, and is sleeved outside the external tubular portion 212. The liquid storage chamber 35 is formed between the glass sleeve 33 and the external tubular portion 212. In order to facilitate for observing the residual amount of the tobacco liquid in the atomizer, the outer supporting bracket 32 in the illustrated embodiment further defines a window (not shown), the tobacco liquid in the atomizer can be observed through the window and the glass sleeve 33, user can determine whether or not to supply tobacco liquid.

In an alternative embodiment, the air intake passage of the atomizing assembly 2 is provided with an air intake auxiliary heating member 242 for heating the air in the air intake passage, the air intake passage is provided with an air intake temperature sensor 222 in the air intake opening 213 for performing a real-time detection of a temperature of the air in the air intake opening 213. The air outlet 261 is provided with an air outlet temperature sensor 241 for performing a real-time detection of a temperature of the air in the air outlet 261. The liquid storage chamber 35 is provided with a tobacco liquid auxiliary heating member 312 for heating the tobacco liquid and a tobacco liquid temperature sensor 313 for performing a real-time detection of a temperature of the tobacco liquid.

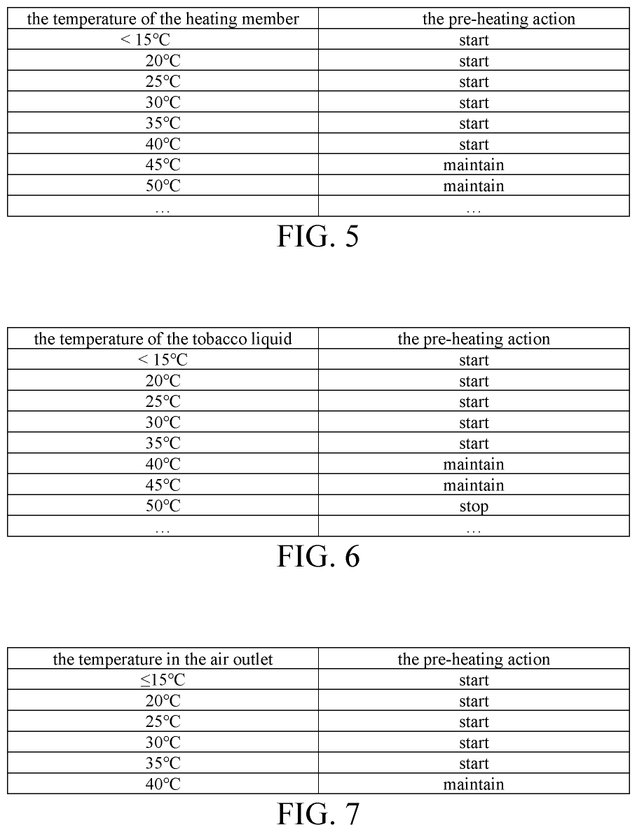

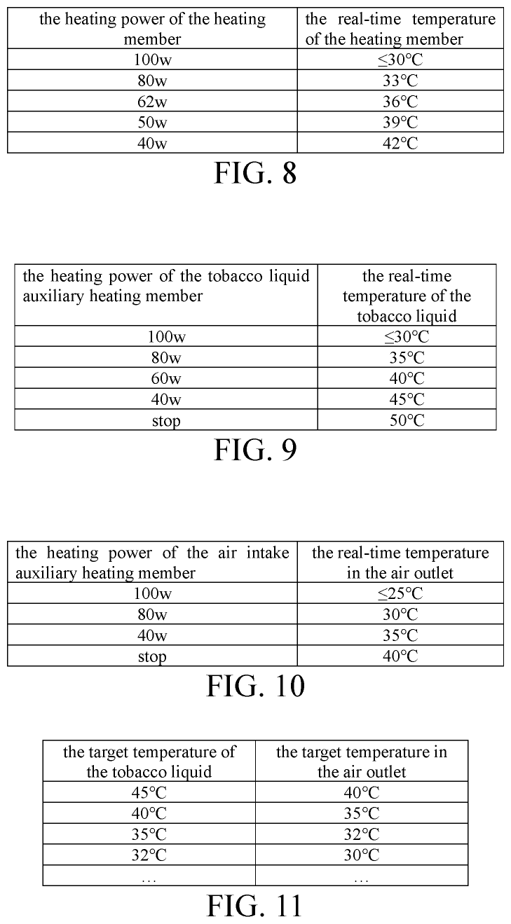

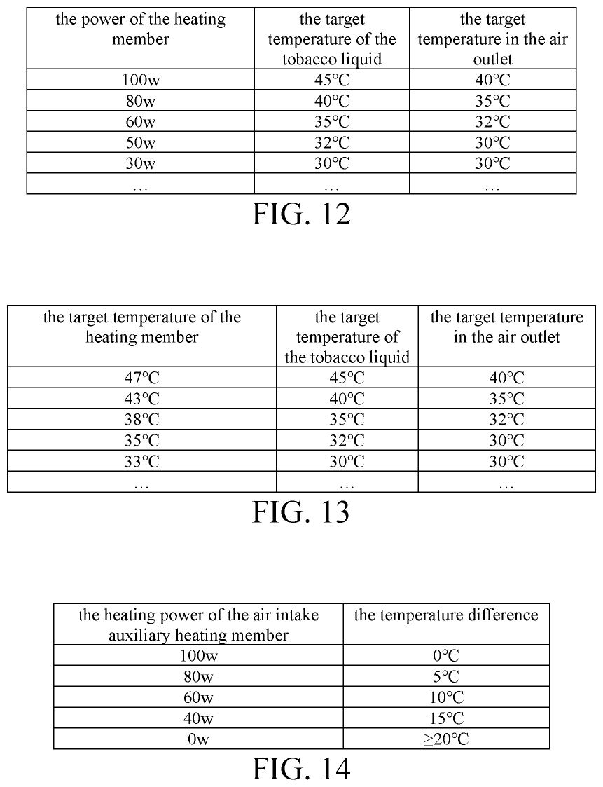

In an illustrated embodiment, a pre-heating control information can be configured and stored in the main controller. The pre-heating control information of the electronic cigarette can include at least one of the following corresponding relations: a corresponding relation (as shown in FIG. 5) between a temperature (the temperature is measured by a temperature probe or other instruments) of the heating member and a pre-heating action; a corresponding relation (as shown in FIG. 6) between a temperature of the tobacco liquid and a pre-heating action; a corresponding relation (as shown in FIG. 7) between a temperature in the air outlet and a pre-heating action; a corresponding relation (as shown in FIG. 8) between a real-time temperature of the heating member and a heating power of the heating member; a corresponding relation (as shown in FIG. 9) between a real-time temperature of the tobacco liquid and a heating power of the tobacco liquid auxiliary heating member; a corresponding relation (as shown in FIG. 10) between a real-time temperature in the air outlet and a heating power of the air intake auxiliary heating member; a corresponding relation (as shown in FIG. 11) between a target temperature of the tobacco liquid and a target temperature in the air outlet; a corresponding relation (as shown in FIG. 12) between a target temperature in the air outlet and a power of the heating member; a corresponding relation (as shown in FIG. 13) between a target temperature in the air outlet, a target temperature of the tobacco liquid, and a target temperature of the heating member; and a corresponding relation (as shown in FIG. 14) between a difference that between the temperature in the air intake opening and the temperature in the air outlet, and a heating power of the air intake auxiliary heating member. It should be noted that, the value of aforementioned pre-heating control information should be treated as a value in a referenced embodiment. In other alternative embodiment, it can be substituted by other values. It can be understood that, the presentation form of the pre-heating control information is not limited hereby, for example, it can be readable storage information such as a form, a mapping relation or a picture.

It should be noted that, the temperature in the air intake opening and the temperature in the air outlet indicate the air temperature in the air intake opening and the air temperature in the air outlet.

In the illustrated embodiment, during the pre-heat process, a real-time temperature of the corresponding component (for example, the heating member, the tobacco liquid auxiliary heating member and the air intake auxiliary heating member) of the atomizer or a real-time temperature of the corresponding position (for example, the air intake opening, the air outlet and the atomizing chamber) is detected timely, the atomizer is controlled to pre-heat according to the detected temperature and the pre-heating control information.

For convenience, in the following pre-heating control information, a pre-heating control form is taken as an example.

Specifically, in a specified embodiment, the pre-heating control form includes a corresponding relation between a temperature of the heating member shown in FIG. 5 and a pre-heating action, the main controller controls the heating member to conduct a pre-heating when a temperature of the heating member is less than a preset temperature i.e. 45 degrees of the heating member, further, a pre-heating power is adjusted according to a difference between a real-time temperature as shown in FIG. 8 of the heating member and the preset temperature, until a temperature of the heating member is equivalent to or greater than the preset temperature i.e. 45 degrees of the heating member, the present pre-heating power is maintained to conduct the pre-heating.

In a specified embodiment, in the pre-heating control form as shown in FIG. 8, the preset target temperature of the heating member is 45 degrees, prior to pre-heating, the initial temperature of the heating member is less than or equivalent to 30 degrees, at the time, a heating power of the heating member is 100 watts, when a temperature of the heating member rises to 33 degrees, a heating power is decreased from 100 watts to 80 watts. When a temperature of the heating member further has a 3 degrees increase and rises to 36 degrees, a heating power is decreased from 80 watts to 62 watts. When a temperature of the heating member further has a 3 degrees increase and rises to 39 degrees, a heating power is decreased from 62 watts to 50 watts. When a temperature of the heating member rises to 42 degrees, a heating power is decreased from 50 watts to 40 watts. When a temperature of the heating member rises to 45 degrees the preset temperature of the heating member, the heating member stops the work. The corresponding relation between a real-time temperature of the heating member and a pre-heating power of the heating member can be a linear relation, and can also be a non-linear relation. In the embodiment as shown in FIG. 8, the corresponding relation between a real-time temperature of the heating member and a pre-heating power of the heating member is a non-linear relation. In the illustrated embodiment, when a temperature of the heating member is increased gradually, a heating power is decreased gradually, and the decreasing gradient is decreased gradually. In an embodiment not shown, when a temperature of the heating member ranges from less than 25 degrees to reach 36 degrees, a heating power of the heating member maintains at 100 watts, when the temperature reaches 36 degrees, the heating power of the heating member is decreased from 80 watts to 60 watts. When a temperature of the heating member further has a 3 degrees increase and rises to 39 degrees, a heating power is decreased from 60 watts to 40 watts. When a temperature of the heating member rises to 45 degrees the preset temperature of the heating member, the heating member stops to heat.

In a specified embodiment, the pre-heating control form as shown in FIG. 6 includes a corresponding relation between a temperature of the tobacco liquid and a pre-heating action, when a temperature of the tobacco liquid is less than a give temperature i.e. 40 degrees, the main controller starts to employ the tobacco liquid auxiliary heating member to pre-heat the tobacco liquid in the liquid storage assembly. Further, a pre-heating power is adjusted according to a difference as shown in FIG. 9 between a real-time temperature of the tobacco liquid and the preset temperature of the tobacco liquid, until a temperature of the tobacco liquid is equivalent to or greater than the preset temperature i.e. 50 degrees, the present power is maintained to conduct a pre-heating.

As shown in FIG. 9, prior to pre-heating, the initial temperature of the tobacco liquid is less than or equivalent to 30 degrees, at the time, a heating power of the tobacco liquid auxiliary heating member is 100 watts, when a temperature of the tobacco liquid has a 5 degree increase and rises to 35 degrees, a heating power is decreased from 100 watts to 80 watts. When a temperature of the tobacco liquid further has a 5 degrees increase and rises to 40 degrees, a heating power is decreased from 80 watts to 60 watts . . . When a temperature of the heating member further rises to 50 degrees, the tobacco liquid auxiliary heating member stops pre-heating. When a temperature of the tobacco liquid increases gradually, a heating power of the tobacco liquid subsidiary member is decreased gradually. The corresponding relation between a real-time temperature of the tobacco liquid and a pre-heating power of the tobacco liquid auxiliary heating member can be a linear relation, and can also be a non-linear relation. In the embodiment as shown in FIG. 9, the corresponding relation between a real-time temperature of the tobacco liquid and a pre-heating power of the tobacco liquid auxiliary heating member is a linear relation.

In a specified embodiment, the pre-heating control form as shown in FIG. 7 includes a corresponding relation between a temperature in the air outlet and a pre-heating action. When the temperature in the air outlet is less than or equivalent to a preset temperature i.e. 40 degrees in the air outlet, the main controller is started to employ the air intake auxiliary heating member to pre-heat the air entering the atomizer. Further, a heating power of the air intake auxiliary heating member is adjusted according to a difference as shown in FIG. 10 between a real-time temperature in the air outlet and the preset temperature in the air outlet, until the temperature in the air outlet is equivalent to or greater than the preset temperature i.e. 40 degrees, the present power is maintained to conduct the pre-heating.

As shown in FIG. 10, prior to pre-heating, the initial temperature in the air outlet is less than or equivalent to 25 degrees, at the time, a pre-heating power of the air intake auxiliary heating member is 100 watts, when the temperature in the air outlet rises to 30 degrees, a heating power is decreased from 100 watts to 80 watts. When the temperature in the air outlet further has a 5 degrees increase and rises to 35 degrees, a heating power is decreased from 80 watts to 60 watts. When the temperature in the air outlet rises to 40 degrees, a heating power is decreased from 60 watts to 40 watts. When the temperature in the air outlet is increased gradually, a heating power of the air intake auxiliary heating member is decreased gradually. In the illustrated embodiment, the corresponding relation between a difference that between a real-time temperature in the air outlet and the preset temperature, and a pre-heating power of the air intake auxiliary heating member can be a linear relation, and can also be a non-linear relation. In the embodiment as shown in FIG. 10, the corresponding relation between a difference that between a real-time temperature in the air outlet and the preset temperature, and a pre-heating power of the air intake auxiliary heating member is a non-linear relation.

In a specified embodiment, the pre-heating control form as shown in FIG. 7 includes a corresponding relation between a temperature in the air outlet and a pre-heating action. The main controller adjusts the working state of the air intake auxiliary heating member according to the temperature in the air outlet. When the temperature in the air outlet is greater than a preset temperature i.e. 40 degree in the air outlet, the air intake auxiliary heating member is not switched on, the working state remains unchanged. When the temperature in the air outlet is less than the preset temperature i.e. 40 degrees in the air outlet, it starts to employ the air intake auxiliary heating member to pre-heat the air entering the atomizer. Further, a heating power of the air intake auxiliary heating member is adjusted according to a temperature difference between the air intake opening and the air outlet, until the temperature in the air outlet is equivalent to or greater than the preset temperature i.e. 40 degrees, the present power is maintained to conduct the pre-heating

In a specified embodiment, as shown in FIG. 14, in a corresponding relation between a temperature difference that between the air intake opening and the air outlet, and a heating power of the air intake auxiliary heating member, when the temperature difference is less, the pre-heating power (a heating power) is less. For example, the temperature difference of 0 degree is corresponding to a heating power of 100 watts, the temperature difference of 5 degrees is corresponding to a heating power of 80 watts, the temperature difference of 10 degrees is corresponding to a heating power of 60 watts, the temperature difference of 15 degrees is corresponding to a heating power of 40 watts, the temperature difference more than 20 degrees is corresponding to a heating power of 20 watts. The corresponding relation between a temperature difference that between the air intake opening and the air outlet, and a pre-heating power of the air intake auxiliary heating member can be a linear relation, and can also be a non-linear relation, in the illustrated embodiment, it is a linear relation. In the illustrated embodiment, a heating power is controlled by the temperature difference, not only the temperature change of the air is homogenous, the inhalation experience is improved, but also an energy saving effect is achieved.

In a specified embodiment, the pre-heating control form as shown in FIG. 11 includes a corresponding relation between a target temperature of the tobacco liquid and a target temperature in the air outlet, in an embodiment, one of a target temperature of the tobacco liquid and a target temperature in the air outlet is selected by user via the inputting module, then the main controller invokes the pre-heating control form to obtain the other temperature information, and controls the tobacco liquid auxiliary heating member and the air intake auxiliary heating member to conduct a heating, until both the temperature of the tobacco liquid and the temperature in the air outlet reach a target temperature.

It can be understood that, one of aforementioned target temperature of the tobacco liquid and aforementioned target temperature in the air outlet selected by user can be configured automatically by the main controller, or can be set when leaving the factory.

In a specified embodiment, the pre-heating control form as shown in FIG. 12 includes a corresponding relation between the power of the heating member, a target temperature of the tobacco liquid, and a target temperature in the air outlet, in an alternative embodiment, user selects 40 degrees as the target temperature of the tobacco liquid via the inputting module, the main controller invokes the pre-heating control form, the pre-heating temperature in the air outlet is automatically configured as 35 degrees according to the pre-heating control form, a heating power of the heating member remains at 80 watts. The tobacco liquid auxiliary heating member and the air intake auxiliary heating member conduct a heating work at the same time. When the temperature in the air outlet reaches 35 degrees first, thus the temperature in the air intake opening is controlled to be constant, the tobacco liquid auxiliary heating member continues to work, until the temperature of the tobacco liquid reaches 40 degrees. Or, when the temperature of the tobacco liquid reaches 40 degrees first, thus the temperature of the tobacco liquid is controlled to be constant, the air intake auxiliary heating member continues to work, until the temperature in the air outlet reaches 35 degrees, the air intake auxiliary heating member stops heating. When pre-heating, user selects a preset target pre-heating temperature via the inputting module, the temperature can be one of the temperature in the air outlet or the temperature of the tobacco liquid, the other one temperature can be acquired directly according the pre-heating control form, the main controller invokes the pre-heating control form and controls the auxiliary heating member to conduct a pre-heating according to the pre-heating control form, causing the temperature in the air intake opening and the temperature of the tobacco liquid to reach the preset temperature one by one.

It should be noted that, in the illustrated embodiment, one of the pre-heating temperature in the air outlet and the pre-heating temperature of the tobacco liquid is selected by user firstly, in other alternative embodiments, the pre-heating temperature in the air outlet or the pre-heating temperature of the tobacco liquid is configured when leaving the factory, or is assigned by the main controller. The main controller actively invokes the pre-heating control form directly, and controls the air intake auxiliary heating member and the tobacco liquid auxiliary heating member to work according to the pre-heating control form. It does not require user to set.

In a specified embodiment, the pre-heating control form as shown in FIG. 13 includes a corresponding relation between a target temperature in the air outlet, a target temperature of the tobacco liquid, and a target temperature of the heating member. In an alternative embodiment, user selects one of the three temperatures: a target temperature in the air outlet, a target temperature of the tobacco liquid, and a target temperature of the heating member, the main controller invokes the other two temperature information from the pre-heating control form, and controls the air intake auxiliary heating member, the tobacco liquid auxiliary heating member and the heating member to conduct a heating at the same time, and controls the temperature of the tobacco liquid, the temperature of the heating member, and the temperature in the air outlet to reach a preset temperature in the pre-heating control form one by one, or at the same time.

For example, when a target temperature of the tobacco liquid selected by user is 45 degrees, at the time, prior to pre-heating, the actual temperature of the tobacco liquid is 25 degrees, the actual temperature in the air outlet is 20 degrees, the actual temperature of the heating member is 30 degrees. At the time, the main controller invokes the pre-heating control form, it can be acquired that the target temperature in the air outlet is 40 degrees, the target temperature of the heating member is 47 degrees, thus the main controller controls the air intake auxiliary heating member, the heating member and the tobacco liquid auxiliary heating member to perform a heating, when the actual temperature of the tobacco liquid reaches the target temperature of the tobacco liquid, i.e. 45 degrees, thus the tobacco liquid auxiliary heating member stops heating, until the temperature in the air outlet reaches the target value 40 degrees subsequently, then the air intake auxiliary heating member stops heating, and finally, when the temperature of the heating member reaches 47 degrees, the heating member stops heating. When user selects a target temperature of the heating member via the inputting module, the working process of the electric cigarette is similar to that of selecting a target temperature of the tobacco liquid, which is not specified described herein. It can be understood that, the selecting process by user can be substituted by the main controller's distributing or the factory setting.

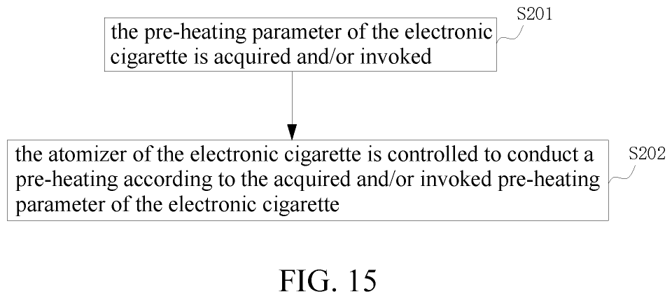

On basis of aforementioned electronic cigarette, in the pre-heating method of the electronic cigarette provided by the illustrated embodiment, it can include the following steps as shown in FIG. 15:

In step S201, the pre-heating parameter of the electronic cigarette is acquired and/or invoked;

In step S202, the atomizer of the electronic cigarette is controlled to conduct a pre-heating, according to the acquired and/or invoked pre-heating parameter of the electronic cigarette.

In an alternative embodiment, the pre-heating parameter includes a pre-heating power/voltage, a pre-heating time period and/or a pre-heating control form of the electronic cigarette. In an alternative embodiment, the acquired pre-heating parameter of the electronic cigarette includes the pre-heating parameter acquired by the main controller after the pre-heating parameter is inputted into the inputting module by user. The step of invoking the pre-heating parameter of the electronic cigarette includes invoking the pre-stored pre-heating control information by the main controller. The step of acquiring and invoking the pre-heating parameter of the electronic cigarette includes inputting a part of the pre-heating parameter into the inputting module by user, invoking the pre-heating control information to obtain the residual part of the pre-heating parameter by the main controller.

In an alternative embodiment, the pre-heating control information includes a corresponding relation between a target temperature of the tobacco liquid and a target temperature in the air outlet, the pre-heating method further includes:

A target temperature is firstly determined, the target temperature is one of a target temperature of the tobacco liquid and a target temperature in the air outlet, the main controller acquires the other one of the target temperature of the tobacco liquid and the target temperature in the air outlet, according to the pre-heating control information, and controls the tobacco liquid auxiliary heating member and the air intake auxiliary heating member to heat, until both the temperature in the air outlet and the temperature of the tobacco liquid reaches the target temperature.

In an alternative embodiment, the pre-heating control information includes a corresponding relation between a target temperature in the air outlet, a target temperature of the tobacco liquid, and a target temperature of the heating member. The pre-heating method further includes:

A target temperature is firstly determined, the target temperature is one of the three temperatures: the target temperature in the air outlet, the target temperature of the tobacco liquid, and the target temperature of the heating member. The main controller invokes the other two temperature information from the pre-heating control information.

Or, two target temperatures are firstly determined, the target temperatures are two of the three temperatures: the target temperature in the air outlet, the target temperature of the tobacco liquid, and the target temperature of the heating member, the main controller invokes the other one temperature information from the pre-heating control information.

The main controller controls the air intake auxiliary heating member, the tobacco liquid auxiliary heating member and the heating member to conduct a heating at the same time, and controls the temperature of the tobacco liquid, the temperature of the heating member, and the temperature in the air outlet to reach a preset temperature in the pre-heating control information one by one, or at the same time

It can be understood that, aforementioned pre-heating method can serve as a specified embodiment for acquiring and invoking the pre-heating parameter of the electronic cigarette.

It can be understood that, determining a target temperature indicates that user can select a pre-heating temperature by the inputting module or can directly input a target temperature by the inputting module. Optionally, when user inputs directly by the inputting module, the target temperature has a maximum value and/or a minimum value, if the temperature value inputted by user is greater than the maximum value or less than the minimum value, thus the input is invalid, the main controller gives a prompting message. Optionally, the pre-heating control information are not corresponding to the value inputted by user one by one, for example, the pre-heating temperature set in the main controller which can be inputted ranges from 20 degrees to 40 degrees, and the pre-heating temperature in the pre-heating control information are divided into four ranges: 20 degrees to 25 degrees, 25 degrees to 30 degrees, 30 degrees to 35 degrees, and 35 degrees to 40 degrees. When user inputs 28 degrees which falls into the second range, i.e. 25 degrees to 30 degrees, the main controller determines that at least one of a target temperature in the air outlet, a target temperature of the tobacco liquid, and a target temperature of the heating member is in the second range, and the other target temperatures can be acquired.

In a specified embodiment, prior to the step of acquiring and/or invoking the pre-heating parameter of the electronic cigarette, the method further includes initializing the electronic cigarette.

In a specified embodiment, an air intake opening temperature sensor, an air outlet temperature sensor and/or a tobacco liquid temperature sensor are included. The air intake opening temperature sensor, the air outlet temperature sensor and the tobacco liquid temperature sensor are connected to the main controller via a signal connection.

In a specified embodiment, a auxiliary heating member for pre-heating is included.

In a specified embodiment, the auxiliary heating member includes an air intake auxiliary heating member connected to the main controller.

In a specified embodiment, the auxiliary heating member includes a tobacco liquid auxiliary heating member connected to the main controller.

In a specified embodiment, the pre-heating control information includes at least one of the following corresponding relations: a corresponding relation between a temperature of the heating member and a pre-heating action; a corresponding relation between a temperature of the tobacco liquid and a pre-heating action; a corresponding relation between a temperature in the air outlet and a pre-heating action; a corresponding relation between a real-time temperature of the heating member and a heating power of the heating member; a corresponding relation between a target temperature of the tobacco liquid and a target temperature in the air outlet; a corresponding relation between a target temperature in the air outlet, a target temperature of the tobacco liquid, and a heating power of the heating member; and a corresponding relation between a preset temperature in the air outlet, a preset temperature of the tobacco liquid, and a target temperature of the heating member.

In a specified embodiment, the pre-heating control information includes a corresponding relation between a temperature of the tobacco liquid and a heating power of the tobacco liquid auxiliary heating member.

In a specified embodiment, the pre-heating control information includes a corresponding relation between a temperature in the air outlet and a heating power of the air intake auxiliary heating member.

In a specified embodiment, the pre-heating control information includes a corresponding relation between a temperature difference that between the air intake opening and the air outlet, and a heating power of the air intake auxiliary heating member.

In controlling the atomizer of the electronic cigarette to conduct a pre-heating according to the acquired and/or invoked pre-heating parameter of the electronic cigarette, it includes: when the main controller controls the atomizer of the electronic cigarette to conduct a pre-heating according to the acquired and/or invoked pre-heating parameter of the electronic cigarette, the adopted pre-heating ways can include at least one of the following three ways: controlling the air intake auxiliary heating member to pre-heat the air entering the atomizer; controlling the tobacco liquid auxiliary heating member to pre-heat the tobacco liquid in the liquid storage assembly, and controlling the heating member to pre-heat the tobacco liquid in the atomizing head.

Further, when the preset pre-heating parameter invoked by the main controller is the pre-heat control information, the main controller controls at least one of the air intake auxiliary heating member, the tobacco liquid auxiliary heating member, and the heating member to conduct the pre-heating according the pre-heat control information.

In a specified embodiment, after controlling the atomizer of the electronic cigarette pre-heat, the step S202 further includes detecting the inputting module whether there is an inputting operation instruction of inhalation, if there is an inputting operation instruction, the electronic cigarette is started for inhalation.

In the illustrated embodiment, prior to power on, the electronic cigarette pre-heats the tobacco liquid, and a temperature of the corresponding component of the atomizer or a temperature of the corresponding position is detected timely, the pre-heating control strategy is adjusted according to the detected temperature, the atomizer is controlled to pre-heat according to the pre-heating control strategy, until the temperature of the corresponding component of the atomizer or the temperature of the corresponding position reaches the target temperature, thereby the flavor of the atomized tobacco liquid is effective improved, user's experience is improved.

Embodiments of the disclosure are described more fully hereinafter with reference to the accompanying drawings. The various embodiments of the disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

The embodiments described above are merely preferred embodiments, but not intended to limit the application. Any modifications, alternatives or improvements made within the principle and spirit of the present application should be interpreted as falling within the protection scope of the present application. The claims are not limited to the features or acts described above. Rather, the proper scope of the disclosure is defined by the appended claims.

1. An electronic cigarette, comprising:
a battery;
an atomizer; and
a main controller connected to the battery and the atomizer;
wherein the main controller is configured to obtain a pre-heating parameter via an inputting module receiving user's inputted instruction, and/or call a preset pre-heating parameter, the main controller is further configured to control the atomizer to conduct a pre-heating, according to the pre-heating parameter.

2. The electronic cigarette according to claim 1, wherein the user's inputted instruction comprises user's operation instructions and data inputted instructions, the user's operation instructions comprises an electronic cigarette initializing instruction, an electronic cigarette pre-heating instruction, and an electronic cigarette inhalation instruction, the date inputted instruction comprises inputted pre-heating parameters, the main controller performs an electronic cigarette initialization after receiving the electronic cigarette initializing instruction, and controls the atomizer to conduct pre-heating after receiving an electronic cigarette pre-heating instruction, and starts the electronic cigarette for inhalation after receiving the electronic cigarette inhalation instruction.

3. The electronic cigarette according to claim 1, wherein the pre-heating parameters comprises a pre-heating power/voltage, and/or, a pre-heating duration, the pre-heating power/voltage is any value falling within the range of the outputting power/outputting voltage of the electronic cigarette, or is any one among multiple pre-heating powers/pre-heating voltages, the pre-heating duration is any value falling within the range of a preset time periods, or is any one among multiple pre-heating durations.

4. The electronic cigarette according to claim 1, wherein the main controller is configured to store the pre-heating parameter of the electronic cigarette inputted by the inputting module, when the main controller does not receive the inputting pre-heating parameter, a previous saved pre-heating parameter of the electronic cigarette is assigned as the present pre-heating parameter of the electronic cigarette by the main controller.

5. The electronic cigarette according to claim 1, wherein the atomizer of the electronic cigarette comprises a liquid storage assembly and an atomizing assembly, the liquid storage assembly defines a liquid storage chamber, the atomizing assembly comprises an atomizing head, an inner of the atomizing head is provided with a heating member and defines an atomizing chamber, the atomizing assembly forms an air intake passage outside the atomizing head, the air intake passage is in communication with the atomizing chamber.

6. The electronic cigarette according to claim 1, wherein the preset pre-heating parameter comprises a pre-heating control information of the electronic cigarette, the pre-heating control information comprises a corresponding relation between a temperature of a heating member and a pre-heating action, when the temperature of the heating member is less than a preset temperature of the heating member, the main controller controls the heating member to heat, until the temperature of the heating member is equivalent to or greater than the preset temperature of the heating member.

7. The electronic cigarette according to claim 5, wherein the main controller is further configured to adjust a pre-heating power according to a difference between a real-time temperature of the heating member and the preset temperature.

8. The electronic cigarette according to claim 5, wherein the air intake passage is provided with an air intake auxiliary heating member for heating the air in the air intake passage, the air intake passage comprises an air intake opening and an air outlet, the air intake opening is provided with an air intake temperature sensor for detecting the air temperature in the air intake opening, and the air outlet is provided with an air outlet temperature sensor for detecting the air temperature in the air outlet.

9. The electronic cigarette according to claim 8, wherein the preset pre-heating parameter comprise a pre-heating control information of the electronic cigarette, the reheating control information comprises a corresponding relation between a temperature in the air outlet and a pre-heating action, when the temperature of in the air outlet is less than a preset temperature in the air outlet, the main controller starts to employ the air intake auxiliary heating member to pre-heat the air entering the atomizer, until the temperature in the air outlet is equivalent to or greater than the preset temperature in the air outlet.

10. The electronic cigarette according to claim 8, wherein the pre-heating control information comprises a corresponding relation that between a temperature difference between the air intake opening and the air outlet, and a heating power of the air intake auxiliary heating member, when the temperature difference between the air intake opening and the air outlet is decreased, the pre-heating power is decreased.

11. The electronic cigarette according to claim 5, wherein the liquid storage chamber is provided with a tobacco liquid auxiliary heating member for heating the tobacco liquid, and a tobacco liquid temperature sensor for detecting the temperature of the tobacco liquid.

12. The electronic cigarette according to claim 11, wherein the preset pre-heating parameter comprise a pre-heating control information of the electronic cigarette, the reheating control information comprises a corresponding relation between a temperature of the tobacco liquid and a pre-heating action, when the temperature of the tobacco liquid is less than a preset temperature of the tobacco liquid, the main controller starts to employ the tobacco liquid auxiliary heating member to pre-heat the tobacco liquid in the liquid storage assembly, until the temperature of the tobacco liquid is equivalent to or greater than the preset temperature of the tobacco liquid.

13. A pre-heating method of an electronic cigarette, comprising:
acquiring and/or invoking a pre-heating parameter of the electronic cigarette; and
controlling an atomizer of the electronic cigarette to conduct a pre-heating according to the acquired and/or invoked pre-heating parameter of the electronic cigarette.

14. The pre-heating method of an electronic cigarette according to claim 13, wherein in the step of acquiring and/or invoking a pre-heating parameter of the electronic cigarette, the pre-heating parameters comprises a pre-heating power/voltage, and/or, a pre-heating duration.

15. The pre-heating method of an electronic cigarette according to claim 14, wherein the electronic cigarette compromises a main controller and an inputting module connected to the main controller, the step of acquiring a pre-heating parameter of the electronic cigarette comprises acquiring the pre-heating parameter inputted by the inputting module via the main controller, the step of invoking a pre-heating parameter of the electronic cigarette comprises invoking a preserved pre-heating control information by the main controller, the step of acquiring and invoking the pre-heating parameter of the electronic cigarette comprises acquiring a part of the pre-heating parameter inputted into the inputting module by the main controller, and acquiring the residual part of the pre-heating parameter by invoking the pre-heating control information via the main controller.

16. The pre-heating method of an electronic cigarette according to claim 13, wherein the atomizer of the electronic cigarette comprises a liquid storage assembly and an atomizing assembly, the liquid storage assembly defines a liquid storage chamber, the atomizing assembly comprises an atomizing head, an inner of the atomizing head is provided with a heating member and defines an atomizing chamber, the atomizing assembly forms an air intake passage outside the atomizing head, the air intake passage is in communication with the atomizing chamber, the air intake passage is provided with an air intake auxiliary heating member for heating the air in the air intake passage, the air intake passage comprise an air intake opening and an air outlet, the air intake opening of the air intake passage is provided with an air intake temperature sensor for detecting the air temperature in the air intake opening, and the air outlet is provided with an air outlet temperature sensor for detecting the air temperature in the air outlet, the liquid storage chamber is provided with a tobacco liquid auxiliary heating member for heating the tobacco liquid, and a tobacco liquid temperature sensor for detecting the temperature of the tobacco liquid.

17. The pre-heating method of an electronic cigarette according to claim 14, wherein the pre-heating control information comprises at least one of the following corresponding relations: a corresponding relation between a temperature of the heating member and a pre-heating action; a corresponding relation between a temperature of the tobacco liquid and a pre-heating action; a corresponding relation between a temperature in the air outlet and a pre-heating action; a corresponding relation between a real-time temperature of the heating member and a heating power of the heating member; a corresponding relation between a real-time temperature of the tobacco liquid and a heating power of the tobacco liquid auxiliary heating member; a corresponding relation between a real-time temperature in the air outlet and a heating power of the air intake auxiliary heating member; a corresponding relation between a target temperature of the tobacco liquid and a target temperature in the air outlet; a corresponding relation between a target temperature in the air outlet, a target temperature of the tobacco liquid, and a pre-heating power; a corresponding relation between a target temperature in the air outlet, a target temperature of the tobacco liquid, and a target temperature of the heating member; and a corresponding relation between a difference that between the temperature in the air intake opening and the temperature in the air outlet, and a heating power of the air intake auxiliary heating member.

18. The pre-heating method of an electronic cigarette according to claim 13, wherein when the electronic cigarette initializing instruction is received, the main controller invokes the pre-heating parameter of the electronic cigarette automatically, and controls the atomizer of the electronic cigarette to pre-heat.

19. The pre-heating method of an electronic cigarette according to claim 16, wherein the pre-heating control information comprises a corresponding relation between a target temperature of the tobacco liquid and a target temperature in the air outlet, the pre-heating method further comprises:
determining a target temperature first, wherein the target temperature is one of the target temperature of the tobacco liquid and the target temperature in the air outlet; and
acquiring the other one temperature information from the target temperature of the tobacco liquid and the target temperature in the air outlet by the main controller, according the pre-heating control information.

20. The pre-heating method of an electronic cigarette according to claim 16, wherein the pre-heating control information comprises a corresponding relation between a target temperature in the air outlet, a target temperature of the tobacco liquid, and a target temperature of the heating member, the pre-heating method further comprises:
determining a target temperature first, wherein the target temperature is one of the three temperatures: the target temperature in the air outlet, the target temperature of the tobacco liquid, and the target temperature of the heating member, and invoking the other two temperature information by the main controller according to the pre-heating control information;
or, determining two target temperatures first, wherein the target temperatures are two of the three temperatures: the target temperature in the air outlet, the target temperature of the tobacco liquid, and the target temperature of the heating member; and invoking the other one temperature information by the main controller, according to the pre-heating control information; and
controlling the air intake auxiliary heating member, the tobacco liquid auxiliary heating member and the heating member by the main controller to conduct a heating at the same time, and controlling the temperature of the tobacco liquid, the temperature of the heating member, and the temperature in the air outlet to reach a preset temperature in the pre-heating control information one by one, or at the same time.
